(19) United States
(12) Patent Application Publication
(10) Pub. No.: US 2019/0042705 A1
(43) Pub. Date: Feb. 7, 2019

(54) REALIZATION METHOD FOR COMPUTER-AIDED SCREENING OF SMALL MOLECULE COMPOUND TARGET APTAMER

(71) Applicant: INSTITUTE OF ANIMAL SCIENCE OF CHINESE ACADEMY OF AGRICULTURAL SCIENCES, Beijing (CN)

(72) Inventors: Nan Zheng, Beijing (CN); Ming Li, Beijing (CN); Jiaqi Wang, Beijing (CN); Yangdong Zhang, Beijing (CN); Fang Wen, Beijing (CN); Songli Li, Beijing (CN); Shengguo Zhao, Beijing (CN)

(73) Assignee: INSTITUTE OF ANIMAL SCIENCE OF CHINESE ACADEMY OF AGRICULTURAL SCIENCES, Beijing (CN)

(21) Appl. No.: 16/074,775

(22) PCT Filed: Jun. 16, 2016
(86) PCT No.: PCT/CN2016/085992

§ 371 Date: Aug. 2, 2018

(30) Foreign Application Priority Data
Feb. 3, 2016 (CN) 201610076616.6

(51) Int. Cl. G06F 19/00

(52) U.S. Cl. CPC G06F 19/701; G06F 19/706

(57) ABSTRACT

The invention relates to a realization method for computer-aided screening of target aptamers and small molecule compounds, which is realized by adopting a molecular docking technology-based reverse virtual screening algorithm and comprises the steps of generating random unrepeated sequences with an appointed length of n based on a sequence length input by a user; modeling a double-stranded DNA structure for each sequence in the random unrepeated sequences and generating a corresponding double-stranded DNA three-dimensional structure file; carrying out format transformation for each generated double-stranded DNA three-dimensional structure file to be used for molecular docking; carrying out format transformation for target small molecules to enable the processed target small molecules to be used for the molecular docking; carrying out molecular docking for each target small molecule and each aptamer; and reading the score files after the molecular docking by two matrix generation functions, and respectively generating two scored matrix files.

### BACKGROUND OF THE INVENTION

### 1. Technical Field

This invention relates to the field of mixing the technologies of computers and biosensors, and specifically to a realization method for computer-aided screening of a small molecule compound target aptamer.

### 2. Description of Related Art

An aptamer refers to a single-stranded oligonucleotide which can form an obvious secondary or tertiary structure and can specifically bind a corresponding target, with high affinity. The single-stranded oligonucleotide can be RNA or DNA, and the length thereof is generally 25-60 nucleotides. For a small molecule compound target, the aptamer is usually developed into a biosensor which is used for detecting content of a corresponding small molecule compound in a sample in a rapid and high-sensitivity manner. However, the development of the biosensors for different small molecule compounds cannot be done without the screening of the corresponding target aptamers. The traditional aptamer screening method is the SELEX technology which mainly comprises the synthesis of a single-stranded randomly-sequenced nucleic acid library, incubation combination of the randomly-sequenced nucleic acid library and the target, separation of the aptamer-target compound, elution of the aptamer from the target, PCR amplification of the aptamer, preparation of a new single-stranded aptamer library by utilizing the PCR product, and repetition of the steps above by the new aptamer library. The process usually needs to be repeated 10-20 times; then the candidate aptamers of the corresponding target can be found through cloning, connection, transformation, plasmid extraction, positive plasmid and traditional nucleic acid sequencing; and then an effective aptamer can be finally determined by combining experiments for testing the affinity between the candidate aptamers and the corresponding target. This shows that the SELEX technology is long in screening time, great in labor intensity and high in screening cost. What is more, as a large number of organic reagents and dangerous chemicals are involved in the whole process, the SELEX technology causes a certain amount of damage to the human body. In particular, as the PCR technology has preferences, the efficiencies of amplification for different nucleotide sequences are different. Partial nucleotide sequences which have a specific binding force with the target may be submerged in the large number of nonspecific binding sequences due to the low amplification efficiency thereof, thereby causing few types of the finally obtained specific binding nucleotide sequence (the aptamer). Even along with the increase of the screening turns, all the specific binding nucleotide sequences may be eliminated due to the PCR preference, thereby resulting in screening failure of the aptamer.

As a result, the SELEX technology has the defects of long screening time, great labor intensity, high screening cost, few screening types, great damage to the human body, relatively low success rate and the like.

The molecular docking technology is a process for finally predicting the affinity between two molecules by utilizing a computer to compute various interaction forces between the two molecules in the presence of different positions and conformations. The molecular docking technology-based computer-aided virtual screening was the earliest used for predicting the affinities between different types of small molecule compounds and the target to screen the small molecule compounds having a strong affinity for the target to serve as the candidate drugs aiming at one target. Soon afterward, a person designed a reverse virtual screening method based on the molecular docking technology. The method is to predict the affinities between different protein targets and the same small molecular compounds so as to screen a protein target which has strong affinity for the small molecular compound to serve for the research of a protein group.

### BRIEF SUMMARY OF THE INVENTION

In order to solve the disadvantages in the prior art, the invention aims at providing a realization method for computer-aided screening of a small molecule compound target aptamer. Through the invention, the purpose of screening the small molecule compound target aptamer rapidly, conveniently, economically, efficiently and environmental-friendly can be realized; and the innate defects of the SELEX technology, such as long screening time, high labor intensity, high screening cost, few screening types, great damage to the human body and relatively low success rate are solved. A foundation for the development of the small molecule compound biosensors is laid.

The purpose of the invention is realized by adopting the technical scheme below:

The realization method for computer-aided screening of a small molecule compound target aptamer, provided by the invention, has the improvement that the method is realized by utilizing the molecular docking technology-based reverse virtual screening algorithm, and comprises the following steps of:

(1) generating random unrepeated sequences with an appointed length of n based on a sequence length input by a user;

(2) modeling a double-stranded DNA structure for each sequence in the random unrepeated sequences and generating a corresponding double-stranded DNA three-dimensional structure file; carrying out format transformation for each generated double-stranded DNA three-dimensional structure file to enable each processed double-stranded DNA three-dimensional structure file to be used for molecular docking in the next step;

(3) carrying out format transformation for target small molecules to enable the processed target small molecules to be used for the molecular docking in the next step;

(4) carrying out molecular docking for each target small molecule and each aptamer; and

(5) reading the score files after the molecular docking by two matrix generation functions, and respectively generating two scored matrix files, wherein the double-stranded DNA sequence with the highest score for the target small molecule can be found in the two scored matrix files.

Further, step (1) comprises the following sub-steps:

1) establishing an input function used for determining the length of the double-stranded DNA;

2) establishing a recursive function, respectively adding each character in A, T, C and G into an initial sequence when entering the recursive function so as to generate four new sequences which have one character more than the former sequences; and generating 4ⁿ different DNA sequences when the input length is n;

3) for the double-stranded DNA, as the two DNA double helixes of the reverse sequence and the positive sequence of the double-stranded DNA are the same molecule, and removal of either one of the helixes is required, removing the reverse sequence automatically by using the molecular docking technology-based reverse virtual screening algorithm, wherein the realization process comprises the steps of adding all the generated sequences to a list and executing a loop statement; judging whether the positive sequences and the reverse sequences are equal by using an if statement; if so, not doing any processing; and if not, deleting the reverse sequences of the sequences from the list;

For the double-stranded DNA, as the two DNA double helixes of the positive complementary sequence and the positive sequence of the double-stranded DNA are the same molecule, and removal of either one of the helixes is required, removing the positive complementary sequence automatically by using the molecular docking technology-based reverse virtual screening algorithm, wherein the realization process comprises the steps of adding all the generated sequences to a list and executing a loop statement; judging whether the positive sequences and the positive complementary sequences are equal by using an if statement; if so, not doing any processing; and if not, deleting the positive complementary sequences of the sequences from the list;

For the double-stranded DNA, as the two DNA double helixes of the reverse complementary sequence and the positive sequence of the double-stranded DNA are the same molecule, and removal of either one of the helixes is required, removing the reverse complementary sequence automatically by using the molecular docking technology-based reverse virtual screening algorithm, wherein the realizing process comprises the steps of adding all the generated sequences to a list and executing a loop statement; judging whether the positive sequences and the reverse complementary sequences are equal by using an if statement; if so, not doing any processing; and if not, deleting the reverse complementary sequences of the sequences from the list; and

generating the random unrepeated sequences with the appointed length of n after removing the reverse sequences, the positive complementary sequences and the reverse complementary sequences from 4n different DNA sequences.

Further, step (2) comprises the following sub-steps:

<1> respectively forming the previously generated random unrepeated sequences with the appointed length of n into a file with the corresponding sequence name and the extension name of .nab which can be identified by a nab module in Ambertools software by utilizing a file storage function;

<2> establishing each double-stranded DNA three-dimensional structure file by utilizing the loop statement; and

<3> carrying out format transformation for each generated double-stranded DNA three-dimensional structure file respectively through dehydrogenation and polar hydrogen and electric field addition operation, and generating a double-stranded DNA three-dimensional structure file used for molecular docking.

Further, step <2> comprises: firstly judging which one is mounted in a judgment system, the modeling module nab of the double-stranded DNA structure or the mpinab supporting parallel computation, through a locate command of a LINUX system, and judging whether the system contains the mpinab through the if statement so as to determine whether to carry out parallel computation;

when establishing a three-dimensional model, the modeling module nab generates an executable file of a.out and judges whether the a.out is completely generated through a complete generation function; and after judging the fact that the a.out is really generated, further executes the a.out file through the system to generate a corresponding double-stranded DNA three-dimensional structure file.

Further, the dehydrogenation operation in step <3> is realized through a dehydrogenation function and comprises the steps of: adding each row of the generated double-stranded DNA three-dimensional structure file into a list by utilizing a file reading function; judging each row of the double-stranded DNA three-dimensional structure file by utilizing the loop statement and the if statement; judging whether the rows are the rows corresponding to hydrogen atoms; if so, not carrying out any operation; if not, adding the content of the row into a new file which has the name as the corresponding sequence plus -dh.pdb by utilizing a write-in function; and carrying out dehydrogenation for each double-stranded DNA three-dimensional structure file by utilizing the loop statement; and

the polar hydrogen and electric field addition operation comprises the steps of: processing each double-stranded DNA three-dimensional structure file subjected to the dehydrogenation operation by utilizing the loop statement and the prepare-receptor4.py module in Mgltools so as to generate each corresponding double-stranded DNA three-dimensional structure file used for the molecular docking format.

Further, step (3) of carrying out format transformation for target small molecules by utilizing OSS (Open Source Software) open babel comprises the sub-steps of carrying out different types of processing for a small molecule two-dimensional structure file or a three-dimensional structure file format according to classification through the if statement; retaining the full name of the original file to serve as a prefix of the generated file through a text processing statement, thereby avoiding generating files with the same file names and preventing the error of overwriting each other caused by the same files.

Further, step (4) comprises:

A, computing a docking site and a docking range;

B, carrying out molecular docking for the double-stranded DNA by utilizing the molecular docking technology-based reverse virtual screening algorithm; predicting affinities between different double-stranded DNA and a specific small molecule compound; finding all the double-stranded DNA sequences having strong affinities for the target small molecule compound; and determining the stem in the stem-loop of the aptamer, that is, the DNA complementary region; and

C, adding the same polynucleotides at one end of the double-stranded DNA to construct the loop in the stem-loop of the aptamer so as to finally construct a complete aptamer.

Further, step A comprises:

1) determining the docking site of the double-stranded DNA three-dimensional structure file, including, reading the double-stranded DNA three-dimensional structure file, obtaining the three-dimensional coordinate data of all the atoms of the double-stranded DNA and storing the data into the list; sequencing the three-dimensional coordinate data respectively and regarding ½ of the sum of the highest point and the lowest point of each coordinate axis (such as an x-axis) as the center of the corresponding coordinate axis; and regarding the center of the three coordinate axes as the docking site of the double-stranded DNA; and

2) determining the docking range of the double-stranded DNA three-dimensional structure, including, reading the double-stranded DNA structure file, obtaining the three-dimensional coordinate data of all the atoms of the double-stranded DNA and storing the data into the list; sequencing the three-dimensional coordinate data respectively and regarding 1.5 times the differential value of the highest point and the lowest point of each coordinate axis (such as the x-axis) as the docking range of the corresponding coordinate axis, wherein when the docking range of one coordinate axis is greater than 126, the docking range of the coordinate axis is set as 126.

Further, in step (5), generation of the two scored matrix functions comprises:

1) generation of the first scored matrix function, comprising: storing the file names of all the log files generated after the docking into a file named as score.score by utilizing an is command, a pipeline command, a grep command and a redirection command in the LINUX system; storing the file name of each log file into the list through a file reading function; opening each log file by utilizing the loop statement and the file reading function, reading each row of each log file in sequence, then judging whether the row is the maximum score for the docking of each molecule by utilizing the if statement; if not, not carrying out any operation; and if so, adding the corresponding log file name and the corresponding highest docking score into the file named as score.list in sequence by utilizing a file storing function;

2) generation of the second scored matrix function, comprising: reading the file named as ligand.list by utilizing the file reading function and storing each target small molecule name into the list; reading the file named as receptor.list by utilizing the file reading function and storing each aptamer name into the list; opening each log file respectively by utilizing a double-layer loop statement and the file reading function; reading each row of each log file in sequence; then judging whether the row is the maximum score for the docking of each molecule by utilizing the if statement; if not, not carrying out any processing; and if so, adding the corresponding highest docking score to the file named as score2.list by utilizing the file storing function, wherein in the internal circulation, each docking highest score is spaced by a tab; and after one internal circulation is ended, a line break is additionally stored; and a two-dimensional matrix with different target small molecules in the cross rows and different aptamers in the longitudinal columns is finally formed.

Compared with the closest prior art, the technical scheme provided by the invention has the excellent effects below:

According to the invention, the molecular docking technology-based reverse virtual screening method is also utilized for predicting the affinities between different double-stranded DNA and a specific small molecule compound, thereby finding all the double-stranded DNA sequences having strong affinity for the target small molecule compound. After then, shorter random oligonucleotides are connected with one end of the double-stranded DNA to construct different types of aptamers. Finally, the aptamer with high affinity for one small molecule compound target is screened by combining with experimental verification.

Compared with the SELEX technology, the invention can obtain the small molecule compound aptamer with strong binding force only through one-step later combination with experimental verification as a large number of external experiments are replaced by computer prediction. As a result, the invention can realize the purpose of screening the small molecule compound target aptamer rapidly, conveniently, economically, efficiently and environmental-friendly, solves the innate defects of the SELEX technology, such as long screening time, high labor intensity, high screening cost, few screening types, great damage to the human body and relatively low success rate, and lays a foundation for the development of the small molecule compound biosensor.

### BRIEF DESCRIPTION OF THE DRAWINGS

FIG. 1 shows the flow diagram of the realization method for computer-aided screening of the small molecule compound target aptamer provided by the invention.

### DETAILED DESCRIPTION OF THE INVENTION

The detailed description of embodiments is further described in detail by combining with the accompanying drawing.

The description and drawings below fully show the specific realization scheme of the invention, so that technicians in the art can put the specific realization scheme into practice. The other realization schemes may comprise changes in structure, logic, electronics, processes and others. The embodiment only represents the possible change. Unless there is a definite requirement, the independent component and function are selectable, and the operation sequence is changeable. Parts and characteristics of some realization schemes can be comprised in or replace the parts and characteristics of the other realization schemes. The scope of the realization scheme of the invention covers the whole scope of the claims and all the obtainable equivalents of the claims. In the text, the realization schemes of the invention can be represented by the tel in, namely, invention, separately or generally. This is only for convenience rather than automatically limiting the application scope of one simple invention or inventive idea if more than one invention is disclosed in fact.

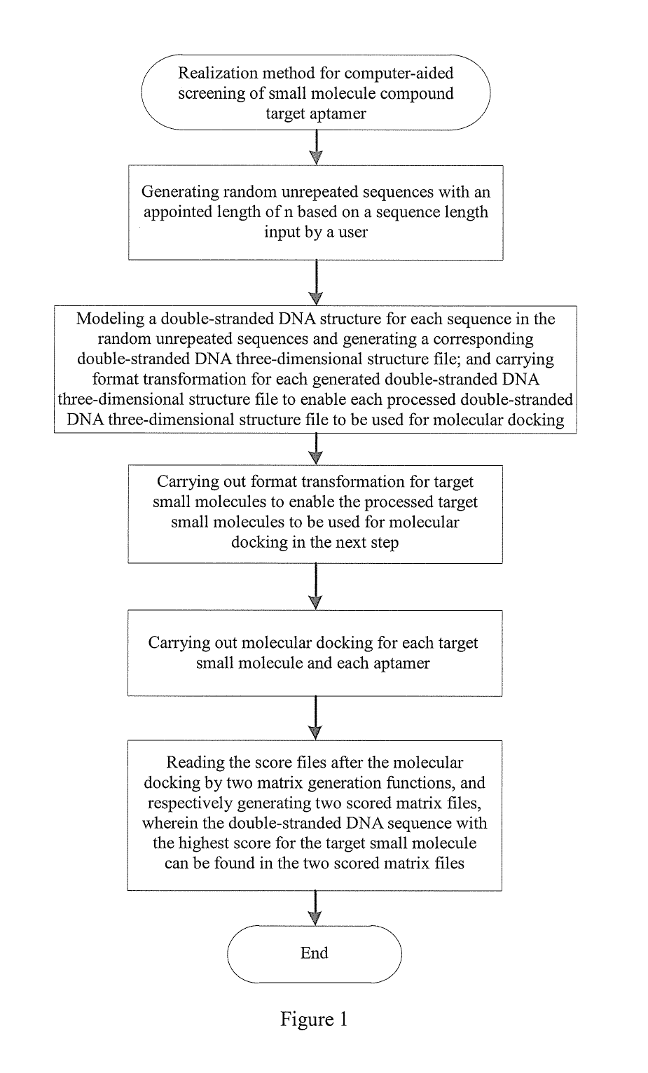

The invention provides a realization method for computer-aided screening of a small molecule compound target aptamer, which is realized by utilizing the molecular docking technology-based reverse virtual screening algorithm. The flow diagram is as shown in FIG. 1 and comprises the following steps:

(1) generating random unrepeated sequences with an appointed length of n based on a sequence length input by a user;

1) firstly, establishing an input function used for determining the length of the double-stranded DNA; then establishing a recursive function, and respectively adding each character in A, T, C and G into an initial sequence when entering the recursive function so as to generate four new sequences which have one character more than the former sequences, so that 4ⁿ different DNA sequences can be generated when the input length is n;

2) as the sequences generated in default are the sequences of the positive strand of the double-stranded DNA, and for the double-stranded DNA, the two DNA double helixes of the reverse sequence and the positive sequence of the double-stranded DNA are the same molecule, removal of either one of the helixes is required, removing the reverse sequence automatically by software. The realizing process of the software comprises the steps of adding all the generated sequences to a list and carrying out a loop statement; judging whether the positive sequences and the reverse sequences are equal by using an if statement; if so, not doing any processing; and if not, deleting the reverse sequences of the sequences from the list;

In the same way, as the two DNA double helixes of the positive complementary sequence and the positive sequence of the double-stranded DNA are the same molecule, removal of either one of the helixes is required, removing the positive complementary sequence automatically by software. The realizing process of the software comprises the steps of adding all the generated sequences to a list and executing a loop statement; judging whether the positive sequences and the positive complementary sequences are equal by using an if statement; if so, not doing any processing; and if not, deleting the positive complementary sequences of the sequences from the list;

In the same way, as the two DNA double helixes of the reverse complementary sequence and the positive sequence of the double-stranded DNA are the same molecule, removal of either one of the helixes is required, removing the reverse complementary sequence automatically by software. The realizing process comprises the steps of adding all the generated sequences to a list and executing a loop statement; judging whether the positive sequences and the reverse complementary sequences are equal by using an if statement; if so, not doing any processing; and if not, deleting the reverse complementary sequences of the sequences from the list; and

So far, a specific algorithm for generating the random unrepeated sequences with the appointed length n after the reverse sequences, the positive complementary sequences and the reverse complementary sequences are removed from the 4ⁿ different DNA sequences is produced.

(2) modeling a double-stranded DNA structure for each sequence in the random unrepeated sequences by utilizing the loop statement and the nab module in Ambertools; generating a corresponding double-stranded DNA three-dimensional structure file; and carrying out format transformation for each generated double-stranded DNA three-dimensional structure file by utilizing the prepare-receptor4.py module in the Mgltools and a dehydrogenation function to enable each processed double-stranded DNA three-dimensional structure file to be used for molecular docking in the next step.

The specific algorithm for generating the double-stranded DNA three-dimensional structure in batches and transforming the double-stranded DNA three-dimensional structure into a target format used for molecular docking in batches is as follows: 1) after the random unrepeated sequences with the appointed length mentioned above are generated, generation of the three-dimensional structure of each type of the double-stranded DNA and format transformation before the docking for the three-dimensional structure of each type of the double-stranded DNA are required to enable each type of the double-stranded DNA to dock with the target small molecule.

2) According to the software, the previously generated random unrepeated sequences with the appointed length are firstly and respectively constructed into a file with the corresponding sequence name and with the extension name of .nab which can be identified by a nab module in Ambertools software by utilizing a file storage function (the file contains the parameters required by the nab for constructing the double-stranded DNA three-dimensional structure). After that, each double-stranded DNA three-dimensional structure is constructed by utilizing the loop statement. As the nab supports the parallel computation, the software firstly judges which is mounted in the system, the nab or the mpinab supporting the parallel computation through the locate command of the LINUX system, and judges whether the system contains the mpinab through the if statement so as to determine whether to carry out parallel computation. When establishing the three-dimensional model, the nab will generate an a.out executable file firstly; and the three-dimensional structure of the corresponding double-stranded DNA can be generated by further carrying out the a.out file through the system. However, as the command for running the a.out at the moment when the generation of the a.out has been executed requires a certain time, the phenomenon of running the command of the a.out being started before the a.out is generated usually occurs, and missing the a.out file and generation failure of the three-dimensional model result. Therefore, the software is provided with a function for judging whether the a.out is completely generated. The a.out cannot be executed before the fact that the a.out is really generated is judged, so that the generation correctness of the three-dimensional structure is ensured.

3) each generated three-dimensional structure file of the double-stranded DNA is respectively subjected to two-step operations, namely, dehydrogenation and polar hydrogen and electric field addition; and the two-step operations respectively correspond to the dehydrogenation function and the prepare-receptor4.py module in Mgltools of the software. The specific process is as follows: (1) realization of the dehydrogenation, including, firstly, adding each row of the generated three-dimensional structure file into a list by utilizing a file reading function; then judging whether each row of the three-dimensional structure file is the row corresponding to the hydrogen atoms by utilizing the loop statement and the if statement; if so, not carrying out any operation; if not, adding the content of the row into a new file which has the name as the “corresponding sequence” plus “-dh.pdb” by utilizing a write-in function; and carrying out dehydrogenation for each double-stranded DNA three-dimensional structure file by utilizing the loop statement. (2) The realization of the polar hydrogen and electric field addition, including, processing each double-stranded DNA three-dimensional structure file subjected to the dehydrogenation operation by utilizing the loop statement and the prepare-receptor4.py module in Mgltools so as to generate each corresponding three-dimensional structure file finally used for the molecular docking format.

(3) An OSS (Open Source Software) open babel is utilized for format transformation of the target small molecule to enable the target small molecule to be used for molecular docking in the next step. The specific process is as follows: 1) molecular docking cannot be carried out unless the structure file of the small molecule compound is the three-dimensional structure of the appointed file. However, the small molecule files which are downloaded from the internet or drawn manually need to be subjected to uniform transformation as the files not only have three-dimensional or two-dimensional structural formats, but also have different file formats. The OSS open babel cannot identify the formats of the small molecule files automatically although having powerful transformation capability; and if the same processing method is used for the small molecule files in different formats and different dimension numbers, the processing time is not only prolonged, but structural errors after the transformation may result.

2) According to the software, different types of processing are carried out for common two-dimensional structural formats or three-dimensional structural formats through the if statement. Meanwhile, the full name of the original file is retained to serve as the prefix of the generated file through a text processing statement, so that generation of files with the same file names is avoided, and the fault of mutual coverage caused by the same file name is prevented.

(4) each target small molecule and each aptamer can be subjected to molecular docking by utilizing the double-layer loop state and the Autodock Vina;

The specific algorithm of the computation of the docking site and the docking range comprises the following: 1) the process of finding the docking site of the double-stranded DNA three-dimensional structure in the program, including, firstly, reading the double-stranded DNA three-dimensional structure file, obtaining the three-dimensional coordinate data of all the atoms of the double-stranded DNA and storing the data into the list; sequencing the three-dimensional coordinate data respectively and regarding ½ of the sum of the highest point and the lowest point of each coordinate axis (such as an x-axis) as the center of the corresponding coordinate axis; and finally, regarding the center of the three coordinate axes as the docking site of the double-stranded DNA. 2) the process of determining the docking range of the double-stranded DNA three-dimensional structure, including, firstly, reading the double-stranded DNA structure file, obtaining the three-dimensional coordinate data of all the atoms of the double-stranded DNA and storing the data into the list; sequencing the three-dimensional coordinate data respectively and regarding 1.5 times the differential value of the highest point and the lowest point of each coordinate axis (such as the x-axis) as the docking range of the corresponding coordinate axis; and when the docking range of one coordinate axis is greater than 126, setting the docking range of the coordinate axis as 126.

The concept of enabling the double-stranded DNA to be subjected to molecular docking and used for screening of the aptamer (single-stranded nucleic acid) as the following: 1) firstly, as the current screening of the aptamer is mainly carried out based on the external experimental SELEX technology, the aptamer screening scheme, in which computer prediction is carried out by utilizing the software and the experimental verification is finally combined, is initiated in the invention. 2) As the aptamers are single-stranded nucleic acids, the scheme in which the software determines the stem (the DNA complementary region) of the aptamer stem-loop by predicting the binding force between the double-stranded DNA and the small molecule compound in advance, and then constructing the loop in the aptamer stem-loop by adding the same polynucleotides at one end of the double-stranded DNA so as to finally construct a complete aptamer is initiated in the invention.

Of course, the loop added at one end of the double helixes of the DNA can also be a random sequence different in length besides the oligomeric single nucleotide which is different in size. As the length of the sequence is greatly shortened in comparison with the length of the initial random sequence used in the traditional SELEX, screening of the target aptamer also can be carried out by utilizing the SELEX with a relatively small number of turns (1-4 turns) in the later period. In short, according to the invention, the strategy of firstly determining the neck part of the aptamer and then adding the loop can greatly shorten the screening time, reduce the labor intensity, decrease the screening cost, add screening types, reduce the damage to the human body and increase the success rate.

In addition, the software can also be used for predicting an acting site and the acting strength of some toxins (such as aflatoxin) and DNA and an acting specific sequence so as to assist in the prediction of the relationship between the toxin and the damage of the nucleic acid and the acting mechanism.

(5) The score file after the molecular docking is read by two matrix generation functions; two scored matrix files are generated respectively; and a double-stranded DNA sequence with the highest score for the target small molecule can be found from the two scored matrix files. The sequence is just the key binding site of the aptamer, so that a large number of external experiments for screening can be left out for the screening of the aptamer, but a series of candidate aptamers with high binding force sites can be obtained by adopting a way of adding the loop at one end of the double-stranded DNA, and the small molecule target aptamer with high binding force can be obtained through a small binding force. The concept of firstly predicting by utilizing a computer, determining the binding site, then adding the oligomeric single nucleotide and then assembling to form a complete aptamer is first reported in the invention.

The generation process of each score file is described below. The software has two scored matrix functions. 1) The realizing process of the first function is as follows: firstly, storing the file names of all the log files generated after the molecular docking into a file named as score.score by utilizing an is command, a pipeline command, a grep command and a redirection command in the LINUX system; storing the file name of each log file into the list through a file reading function; opening each log file by utilizing the loop statement and the file reading function, reading each row of each log file in sequence, then judging whether the row is the maximum score for the docking of each molecule by utilizing the if statement; if not, not carrying out any operation; and if so, adding the corresponding log file name and the corresponding highest docking score into the file named as score.list in sequence by utilizing a file storing function. 2) the realizing process of the second function is as follows: reading the file named as ligand.list by utilizing the file reading function and storing each target small molecule name into the list; then reading the file named as receptor.list by utilizing the file reading function and storing each aptamer name into the list; opening each log file respectively by utilizing a double-layer loop statement and the file reading function; reading each row of each log file in sequence; then judging whether the row is the maximum score for the docking of each molecule by utilizing the if statement; if not, not carrying out any processing; and if so, adding the corresponding highest docking score into the file named as score2.list by utilizing the file storing function. The biggest difference between the realization method and the former methods is the internal circulation; the highest score of each docking is spaced by a tab; after one internal circulation is ended, a line break is additionally stored; and a two-dimensional matrix with different target small molecules in the cross rows and different aptamers in the longitudinal columns is finally formed.

The whole realization method for the computer-aided screening of the small molecule aptamer adopts the realization concept of the Open Source Software; the concept of the software is to establish a free realization method for computer-aided screening of the small molecule compound target aptamer by utilizing the OSS, thereby reducing the threshold of the aptamer screening and enabling the screening of the aptamer to be generalized and popular.

Notes: 1. The software is written by using Python language; and software written in other languages by utilizing the principle of the invention may realize the purpose of screening the small molecule target aptamer.

2. The software is developed based on the LINUX system; and the software developed in other systems by utilizing the principle of the invention may realize the purpose of screening the small molecule target aptamer.

3. Some values of the software are not unchangeable, such as the size of the docking site, which is equal to the range of the aptamer plus 1.5; but the 1.5 can be changed into another value.

4. The name of each module of the software is changeable; for example, AutoDock Vina can be replaced by AutoDock 4.2 or 3.5, or the modules of the software can be replaced by other software having the same functions.

5. A lot of parameters of joining programs between modules are changeable.

6. At present, there is software capable of modeling the single-stranded DNA and generating the three-dimensional structure; if the modeling part of the OSS software is replaced by the software, the principle is also the principle of firstly computing by utilizing the computer and then combining with the experimental verification in the invention.

The biggest advantage of the invention is to develop software which predicts the binding site with the highest binding force through the computer in advance and then adding a plurality of oligomeric single nucleotides different in size to obtain a series of potential aptamers having high binding force with the target small molecule compound. Essentially speaking, a method of combining the virtual screening with the binding force experimental verification is established by utilizing the computer computing rather than the fussy SELEX technology.

The embodiment above is only used for describing the technical scheme of the invention and not intended to limit the scope of the invention. Although the invention is described in detail with reference to the embodiment, technicians in the art still can carry out modifications or equivalent replacements for the specific realization method of the invention. Any modifications and equivalent replacements within the scope of spirit and range of the invention shall fall within the scope of protection of the claims of the applied invention to be approved.

1. A realization method for a computer-aided screening of target aptamers for small molecule compounds, wherein the realization method is implemented by adopting a molecular docking technology-based reverse virtual screening algorithm, comprising steps of:
(1) generating random unrepeated sequences with an appointed length of n based on an input sequence length;
(2) modeling a double-stranded DNA structure for each sequence in the random unrepeated sequences and generating a corresponding double-stranded DNA three-dimensional structure file; carrying out a format transformation for each of the generated double-stranded DNA three-dimensional structure file to enable each of the processed double-stranded DNA three-dimensional structure file to be used for a molecular docking in the next step;
(3) carrying out a format transformation for the small molecule to enable the processed small molecule to be used for the molecular docking in the next step;
(4) carrying out the molecular docking for each of the small molecule compounds and each of the target aptamers; and
(5) reading score files after the molecular docking by two matrix generation functions, and respectively generating two scored matrix files, wherein double-stranded DNA sequences with the highest score for the small molecule compounds can be found in the two scored matrix files.

2. The realization method according to claim 1, wherein the step (1) comprises the following steps of:
1) establishing an input function for determining the sequence length of a double-stranded DNA;
2) establishing a recursive function, respectively adding each character in A, T, C and G into an initial sequence when entering the recursive function so as to generate four new sequences which have one character more than the double-stranded DNA sequence; and generating 4ⁿ different DNA sequences when the input sequence length is n;
3) for the double-stranded DNA, as two DNA double helices of a reverse sequence of the double-stranded DNA and a positive sequence of the double-stranded DNA are the same molecule, and removal of either one of the double-stranded DNA is required, removing the reverse sequence of the double-stranded DNA automatically by using the molecular docking technology-based reverse virtual screening algorithm, wherein a realization process comprises the steps of adding all the generated new sequences to a list and executing a loop statement; judging whether the positive sequence of the double-stranded DNA and the reverse sequence of the double-stranded DNA are equal by using an if statement; if so, not doing any processing; and if not, deleting the reverse sequence of the double-stranded DNA of the new sequences from the list;
for the double-stranded DNA, as the two DNA double helices of a positive complementary sequence of the double-stranded DNA and the positive sequence of the double-stranded DNA are the same molecule, and removal of either one of the double-stranded DNA is required, removing the positive complementary sequence of the double-stranded DNA automatically by using the molecular docking technology-based reverse virtual screening algorithm, wherein the realization process comprises the steps of adding all the generated new sequences to the list and executing the loop statement; judging whether the positive sequence of the double-stranded DNA and the positive complementary sequence of the double-stranded DNA are equal by using the if statement; if so, not doing any processing; and if not, deleting the positive complementary sequence of the double-stranded DNA of the new sequences from the list;
for the double-stranded DNA, as the two DNA double helixes of a reverse complementary sequence of the double-stranded DNA and the positive sequence of the double-stranded DNA are the same molecule, and removal of either one of the double-stranded DNA is required, removing the reverse complementary sequence of the double-stranded DNA automatically by using the molecular docking technology-based reverse virtual screening algorithm, wherein the realizing process comprises the steps of adding all the generated new sequences to the list and executing the loop statement; judging whether the positive sequence of the double-stranded DNA and the reverse complementary sequence of the double-stranded DNA are equal by using the if statement; if so, not doing any processing; and if not, deleting the reverse complementary sequence of the double-stranded DNA of the new sequences from the list; and
generating random unrepeated sequences with the appointed length of n after removing the reverse sequence of the double-stranded DNA, the positive complementary sequence of the double-stranded DNA and the reverse complementary sequence of the double-stranded DNA from 4ⁿ different DNA sequences.

3. The realization method according to claim 1, wherein the step (2) comprises the following steps of:
<1> respectively forming the previously generated random unrepeated sequences with the appointed length of n into a file with a corresponding sequence name and with an extension name of .nab which can be identified by a nab module in Ambertools software by utilizing a file storage function;
<2> establishing each of the double-stranded DNA three-dimensional structure file by utilizing a loop statement; and
<3> carrying out the format transformation for each of the generated double-stranded DNA three-dimensional structure file respectively through a dehydrogenation operation and a polar hydrogen and electric field addition operation and generating the double-stranded DNA three-dimensional structure file used for the molecular docking.

4. The realization method according to claim 3, wherein the step <2> comprises: firstly judging either a modeling module nab of the double-stranded DNA structure or a mpinab supported by a parallel computation is mounted in a judgment system, through a locate command of an LINUX system, and judging whether the system contains the mpinab through the if statement so as to determine whether to carry out the parallel computation;
when establishing a three-dimensional model, generating an executable file of a.out by the modeling module nab and judging whether the executable file of a.out is completely generated through a complete generation function; and after judging the executable file of a.out is generated, further executing the executable file of a.out file through the LINUX system to generate the corresponding double-stranded DNA three-dimensional structure file.

5. The realization method according to claim 3, wherein the dehydrogenation operation in step <3> is realized through a dehydrogenation function and comprises the steps of: adding each row of the generated double-stranded DNA three-dimensional structure file into a list by utilizing a file reading function; judging each row of the double-stranded DNA three-dimensional structure file by utilizing the loop statement and an if statement; judging whether the rows are corresponding to hydrogen atoms; if so, not carrying out any operation; if not, adding the content of the row into a new file which has a name of “corresponding sequence” plus “-dh.pdb” by utilizing a write-in function; and carrying out dehydrogenation for each of the double-stranded DNA three-dimensional structure file by utilizing the loop statement; and
the polar hydrogen and electric field addition operation comprises the steps of: processing each of the double-stranded DNA three-dimensional structure file subjected to the dehydrogenation operation by utilizing the loop statement and a prepare-receptor4.py module in Mgltools so as to generate each of the corresponding double-stranded DNA three-dimensional structure file used for the molecular docking format.

6. The realization method according to claim 1, wherein the step (3) of carrying out the format transformation for the small molecule compounds by utilizing Open Source Software (OSS) open babel comprises the steps of: carrying out different types of processing for a double-stranded DNA two-dimensional structure file or the double-stranded DNA three-dimensional structure file format according to classification through the if statement; retaining a full name of an original file to serve as a prefix of the generated double-stranded DNA two-dimensional structure file or the double-stranded DNA three-dimensional structure file through a text processing statement, thereby avoiding generating files with same file names and preventing an error of overwriting each other caused by the same file names.

7. The realization method according to claim 1, wherein the step (4) comprises:
A, computing a docking site and a docking range;
B, carrying out the molecular docking for a double-stranded DNA by utilizing the molecular docking technology-based reverse virtual screening algorithm; predicting affinities between different double-stranded DNA and a specific small molecule compound; finding all the double-stranded DNA sequences having strong affinities for the target small molecule compounds; and determining a stem in a stem-loop of the target aptamers, that is, a DNA complementary region; and
C, adding same polynucleotides at one end of the double-stranded DNA to construct a loop in the stem-loop of the target aptamers so as to finally construct a complete aptamer.

8. The realization method according to claim 7, wherein the step A comprises:
1) determining the docking site of the double-stranded DNA three-dimensional structure file, including, reading the double-stranded DNA three-dimensional structure file, obtaining a three-dimensional coordinate data of all atoms of the double-stranded DNA and storing the three-dimensional coordinate data into a list; sequencing the three-dimensional coordinate data respectively and taking ½ of the sum of a highest point and a lowest point of each coordinate axis (an x-axis) as the center of the corresponding coordinate axis; and setting the center of three coordinate axes as the docking site of the double-stranded DNA; and
2) determining the docking range of a double-stranded DNA three-dimensional structure, including, reading the double-stranded DNA three-dimensional structure file, obtaining the three-dimensional coordinate data of all the atoms of the double-stranded DNA and storing the three-dimensional coordinate data into the list; sequencing the three-dimensional coordinate data respectively and taking 1.5 times a differential value of the highest point and the lowest point of each coordinate axis (the x-axis) as the docking range of the corresponding coordinate axis; and when the docking range of one coordinate axis is greater than 126, setting the docking range of the coordinate axis as 126.

9. The realization method according to claim 1, wherein the two scored matrix generation functions in the step (5) comprises:
1) generation of a first scored matrix function, comprising: storing file names of all the log files generated after the molecular docking into a file named as score.score by utilizing an is command, a pipeline command, a grep command and a redirection command in the LINUX system; storing the file names of each of the log files into a list through a file reading function; opening each of the log files by utilizing a loop statement and the file reading function, reading each row of each of the log files in sequence, then judging whether the row is a maximum score for the molecular docking of each molecule by utilizing an if statement; if not, not carrying out any operation; and if so, adding the corresponding file names of each of the log files and a corresponding highest docking score into the file named as score.list in sequence by utilizing a file storing function;
2) generation of a second score matrix function, comprising: reading the file named as ligand list by utilizing the file reading function and storing each of the target small molecule compounds name into the list; reading the file named as receptor.list by utilizing the file reading function and storing a name of each of the target aptamers into the list; opening each of the log files respectively by utilizing a double-layer loop statement and the file reading function; reading each row of each of the log files in sequence; then judging whether the row is the maximum score for the molecular docking of each molecule by utilizing the if statement; if not, not carrying out any operation; and if so, adding the corresponding highest docking score into the file named as score2.list by utilizing the file storing function, wherein in an internal circulation, the highest docking score of each of the molecular docking is spaced by a tab; and after one internal circulation is ended, a line break is additionally stored; and a two-dimensional matrix with different target small molecule compounds in cross rows and different target aptamers in longitudinal columns is finally formed.
